(19) United States
(12) Patent Application Publication
(10) Pub. No.: US 2006/0231596 A1
(43) Pub. Date: Oct. 19, 2006

(54) Process for making a welded steel tubular having a weld zone free of untempered martensite

(76) Inventors: Jack A. Gruber, Poland, OH (US); Robert J. Ferguson, Hermitage, PA (US)

Correspondence Address: CALFEE HALTER & GRISWOLD, LLP, 800 SUPERIOR AVENUE, SUITE 1400, CLEVELAND, OH, 44114, US

(21) Appl. No.: 11/107,593

(22) Filed: Apr. 15, 2005

(51) Int. Cl. B23K 31/02

(52) U.S. Cl. 228/146

(57) ABSTRACT

A process for making an untempered martensite-free welded steel tubular is disclosed. The process includes rapid quenching of the steel tubular without formation of untempered martensite, at rates up to about 1600° F./second. There is no post-weld seam annealing process required. Also a welded steel tubular made in accordance with the disclosed process is described.

### TECHNICAL FIELD

The present invention is directed to a process for making a welded steel tubular and untempered martensite-free welded steel tubulars.

### BACKGROUND

Welded steel tubulars are used for a wide variety of applications, for example, in oil and gas pipelines, conduit, automotive, furniture, and structural applications. A welded steel tubular is generally manufactured in a conventional manner by forming steel strip (skelp) into a cylindrical shape by the action of several opposing forming rolls. The two opposing edges of the strip are prepared so that they are presented to a heat source parallel to each other and with minimal, yet controlled, spacing. Application of an external heat source and simultaneous lateral force from forming rolls allows fusion of the abutting edges.

The metallurgical structure thereby created is deformed longitudinally by pressure rolls as the tubular is cooled. The steel tubular generally undergoes post-welding heat treatment after cooling to temper the steel and relieve residual stress.

The quality and performance of a welded steel tubular is influenced by its microstructure, especially in the area surrounding the weld. The area surrounding the weld that is heated, but not melted, is the heat affected zone (HAZ). The microstructure is controlled by the arrangements of the various elements in the steel, and these arrangements are altered by the rate of temperature change caused by welding and cooling.

The common form of iron, the majority component of steel, at room temperature is ferrite, which has a body centered cubic (BCC) crystal lattice. When steel is heated above approximately 1330° F., the ferrite BCC expands to form an austenite crystal lattice with a face centered cubic (FCC) crystal lattice.

The larger austenite FCC crystal allows for larger solute atoms to be dissolved by the iron to form an interstitial solid solution. These solute atoms are called interstitials, and may include carbon, nitrogen, and hydrogen. In an interstitial solid solution, the ratio of the size of the solute atoms to the solvent atoms must be less than 0.59. When the edges of the formed steel strip are heated for welding, the residual interstitials in the steel rapidly diffuse or migrate and dissolve into the austenite FCC lattices that are formed near the weld line. Microstructures that are formed upon continuous cooling include Spheriodized (S), Pearlite (P), Ferrite (F), upper and lower Bainite (B), Martensite (M), and Retained Austenite (RA).

When the steel cools, the austenite FCC lattice may transform into more than one crystal arrangement, which is determined by the cooling rate and alloy composition. Slow cooling, less than about 0.011° F./second, will allow carbon to diffuse out of the austenite FCC crystal lattice in the form of spheroidal or lamellar (plates) iron carbides alternating with ferrite plates called pearlite in a BCC ferrite matrix.

As the rate of cooling is increased so that it is in the range of about 0.011° F./second to about 0.042° F./second, diffusion of carbon from the austenite FCC crystal lattice will transform into a mixture of microstructures of pearlite, ferrite, and bainite with either a BCC or slightly modified BCC crystallographic lattice, some martensite with a modified BCT crystallographic lattice may form in areas of high carbon and nitrogen concentration.

As the rate of cooling is increased so that it is in the range of about 0.042° F./second to about 0.58° F./second or faster, the austenite FCC crystal lattice will transform into microstructures of upper and/or lower bainite and possibly into martensite, if there are high enough concentrations of carbon dissolved into the ferrite matrix.

However in the range of 0.58° F./second to 15° F./second, the microstructure will consist of upper and lower bainite with a small amount of martensite, but no ferrite. If dissipation of heat is equal to or exceeds 15° F./second, then martensite with a modified BCC and/or body centered tetragonal (BCT) crystallographic lattice is formed. Under some conditions FCC austenite is retained below what is termed the martensite finish temperature.

The presence of interstitials favors the formation of martensite. Because the interstitial alloy elements, such as carbon, nitrogen, and hydrogen, rapidly diffuse or migrate during welding, the HAZ of the tubular represents the area where martensite will most likely form.

Martensite is an undesirable microstructure that is harder and less ductile than the BCC ferrite and FCC austenite lattices from which it forms. The BCT martensite crystal lattice increases local residual stress which can exceed the plasticity and tensile strength of the steel matrix and cause micro-fissures to develop. This BCT martensite is readily discernable with reagents such as nital or sodium metabisulfite with optical metallography.

Martensite with a modified BCC crystal lattice, in ultra low carbon steels such as 0.002% carbon and less, has a reduced volumetric change, imparts a minimal amount of residual stress, and has a very low probability of forming micro-fissures. The modified BCC martensite can only be observed at high magnifications with scanning electron microscopy (SEM).

Martensite can be tempered by raising the temperature to between about 500° F. and 1250° F. for a selected period of time. Untempered martensite is unstable at room temperature and will decompose into ferrite and carbide. A concern with untempered martensite is whether the matrix of the steel surrounding the martensite crystals has sufficient plasticity and tensile strength to withstand the residual stresses imposed by the change in volume that accompanies the formation of the martensite without initiating micro-fissures that could lead to catastrophic failure.

If austenite is retained after rapid cooling, the potential for micro-fissures forming in BCT martensite is further increased by the action of external stresses applied to the tubular in various end-use applications. Increased presence of BCT martensite increases the likelihood that catastrophic failure of the welded steel tubular will occur. Micro-fissures may form well beyond the manufacturing cycle. In order to prevent the formation of micro-fissures in a welded steel tubular, conventional processes temper the tubular by application of sufficient thermal energy to accelerate decomposition of, or temper, the martensite.

For practical purposes of cost and productivity, processes for making a welded steel tubular typically include cooling the tubular at a fast rate, generally exceeding approximately 600° F./second, because of operating requirements of, for example, ancillary eddy current and/or ultrasonic nondestructive testing operations. Once the weld is inspected, seam process annealing is often used to temper any martensite formed, thereby relieving the majority of residual stress caused by the formation of martensite upon cooling. In conventional seam process annealing, heat is applied after quenching to increase the temperature of the weld and HAZ to about 1250° F. for a time that depends upon the residual heat in the weld and wall thickness of the tubular. If the temperature of the weld and HAZ exceed the austenizing temperature 1330° F. to 1600° F., the welded tubular must be cooled at a slow rate, less than approximately 0.042° F./second, depending on the localized concentration of free interstitial elements, to prevent the reformation of martensite. This slow rate of cooling is continued until the tubular is less than 700° F. to prevent the reformation of martensite. If the tubular is heated by the induction process, controlling the maximum temperature is even more important to avoid the reformation of martensite. The austenizing temperature depends on the particular alloy composition of the steel, but is generally between about 1330° F. and about 1600° F.

Generally, any welded steel tubular having a pressure rating greater than 3000 psi must be seam process annealed above 1000° F., but less than the austenizing temperature for the steel, to temper the martensite formed during welding and subsequent quenching. For example, the tubing specification of a Type E, Grade B welded steel tubular (classification in ASTM-A-53), requires, as one remedy, that all martensite be heat treated (tempered) above 1000° F. so that no untempered martensite remains in the weld seam and HAZ.

Therefore, the conventional process for producing a welded steel tubular must provide for a slow rate of cooling immediately after welding to prevent formation of martensite, or the process must include post-welding heat treatment to transform the untempered martensite into a tempered martensite. Post-welding heat treatment requires the additional cost associated with line space and the operation of a furnace or seam annealer. Both slow cooling and post-weld heat treatments result in a slower rate of production. Moreover, considerable process control is required to ensure that the weld and the HAZ are slowly cooled, and that all martensite is tempered to prevent delayed formation of micro-fissures associated with BCT martensite.

### SUMMARY

The present invention includes a process for making a welded steel tubular in which a sheet of steel having a first edge and a second edge opposite the first edge is formed into a cylindrical shape. The first edge and the second edge are disposed substantially parallel to and spaced apart from each other. The first edge and second edge are heated to a pre-selected temperature at which the first edge and the second edge are molten or nearly molten.

The first edge and the second edge are joined together into a welded seam, forming a steel tubular. Then the steel tubular and the welded seam are cooled at a rate of about 0.58° F./second or faster, as fast as 1600° F./second. The cooled welded seam is substantially free of untempered martensite. The seam is not heated above about 1200° F. after it has been cooled. There is no post-weld seam annealing process. The steel tubular includes between about 0.01 wt. % and about 0.1 wt. % carbon and between about 0.01 wt. % and about 0.2 wt. % niobium. The ratio of niobium to carbon is between about 0.8 and about 2.1.

In one embodiment, the steel tubular includes between about 0.001 wt. % and about 0.015 wt. % boron and about 0.001 wt. % and about 0.015 wt. % nitrogen. The ratio of boron to nitrogen is between about 0.8 and about 2.1.

The invention also includes a welded steel tubular made in accordance with the process described above.

### DETAILED DESCRIPTION

The present invention is directed to a process of making a steel tubular and to steel tubulars. The invention is described below and above by illustrative embodiments, but is limited only by the claims appended hereto.

In one embodiment of the present invention, a sheet of steel that has a first edge and a second edge opposite the first edge is formed into a cylindrical shape. The sheet of steel is rolled in any conventional way such that the first edge and the second edge are disposed substantially parallel to and spaced apart from each other. In one embodiment, the steel is shaped by the action of opposing horizontal and vertical position rolls that move the edges toward each other. The sheet of steel is conventionally formed, such as is available from any continuous casting process, except as described in greater detail below.

The first edge and the second edge are heated to a pre-selected temperature. The temperature is selected such that the first edge and the second edge are molten or nearly molten. The temperature at which steel melts depends on the alloy of steel, but ranges generally between about 2500° F. to about 2800° F. Thus, the pre-selected temperature is, for example, between about 2500° F. and about 2800° F., such as about 2700° F.

The first edge and the second edge are joined together into a welded seam. This welded seam closes the gap between the first edge and the second edge such that the sheet of steel is now in tubular form. In one embodiment, the welding of the first edge to the second edge is accomplished by conventional electric arc welding. Other embodiments use single or dual submerged arc, laser, continuous butt, electric resistance, gas tungsten, or gas metal arc welding processes. The process used for welding the first edge and the second edge may be selected without departing from the spirit and scope of the invention. In one embodiment the welding is accomplished by conventional electric resistance welding, including applying an electric current to the first edge and the second edge.

After the first edge and the second edge are joined together in a welded seam, the tubular and the welded seam are quenched, or cooled, to a temperature of 400° F. or lower. This quenching is accomplished rapidly, at a rate of greater than about 0.58° F./second, preferably greater than about 15° F./second, for example, at rate of about 800° F./second or greater, and as much as about 1600° F./second. After a tubular made in accordance with the present invention is cooled below 700° F., it is substantially free of untempered martensite. The term “untempered martensite free” means that the matrix of the welded steel tubular has 0% BCT martensite and contains less than about 1%, preferably less than about 0.5%, and, more preferably, less than about 0.1% of modified BCC martensite as visually detected by optical metallography. That is, there is essentially no BCT martensite present in the steel at magnifications of at least about 500×.

The HAZ associated with the first edge and with the second edge also become heated, as described above, and may undergo crystallographic changes. In a welded steel tubular made in a conventional manner, these heat affected zones also contain untempered martensite. The heat affected zones of a welded steel tubular made in accordance with the present invention, however, are also untempered martensite free.

The method of making a welded steel tubular in accordance with the present invention allows for rapid quenching—at least as great as 0.58° F./second and as much as 1600° F./second—and does not require a subsequent process of reheating the tubular or the welded seam above 1000° F., 1200° F., or 1250° F. to temper martensite formed by the rapid quenching of the steel. A welded steel tubular made in accordance with the present invention is untempered martensite free after the original quenching, without the need to anneal the welded seam, as described above for a conventional process.

This method is particularly applicable for the formation of a welded steel tubular from low carbon steel. Low carbon steel, for the purposes of the present invention, is steel having no more than about 0.20 wt. % carbon.

The formation of martensite, it has been determined, can be impeded in low carbon steel by the presence of sufficient niobium such that the weight ratio of niobium to carbon is between about 0.8 and 2.1. It is believed that ratios up to about 10.0 are satisfactory. Niobium is advantageously present in an amount between about 0.01 wt. % and about 0.2 wt. %, and up to about 0.3 wt. %. Niobium may also be present up to the maximum solubility of the niobium in the steel. The presence of carbon is preferably between about 0.01 wt. % and about 0.1 wt. %, but up to as much as about 0.2 wt. %. Use of steel with these concentrations of niobium and carbon in the method of formation of welded steel tubulars discussed above provides untempered martensite-free results in accordance with the present invention.

In one embodiment of the invention, an amount of niobium less than that required by a niobium to carbon weight ratio of 0.8 can be used if the steel further includes an amount of boron in excess of the amount of boron required to combine with the free nitrogen (see below) so that boron can offset an amount of niobium needed to be within the proper niobium to carbon weight range. The weight ratio of the combined weight of niobium and boron to carbon, (Nb+B):C, can range from, for example, about 0.8 to about 2.1, preferably from about 0.8 to about 1.2, and more preferably from about 0.9 to about 1.1. It is believed that ratios up to about 10.0 are satisfactory.

It also has been found that when the steel contains greater than about 0.003% nitrogen, the potential for martensite formation exists despite a lack of excess free carbon. In one embodiment of the invention, the steel for making welded steel tubular includes a weight percentage of boron from about 0.001% to about 0.015%, for example, from about 0.006% to about 0.012%, and preferably from about 0.008% to about 0.01% by weight boron when the steel includes from about 0.001% to about 0.015% nitrogen. The boron combines with free nitrogen to form boronitrides, which, as for the niobium carbides, are too large to fit into the interstitial openings of the FCC austenite crystal lattice. Thus, the presence of the boron also impedes formation of the martensite,

Without intending to be bound by any particular theory, it is believed that the presence of niobium promotes the formation of niobium carbides, and boron promotes the formation of boronitrides, thus binding the loose carbon and nitrogen atoms that would otherwise lodge in the interstitial openings and contribute to the formation of the martensite BCT or modified BCC crystal lattice. Niobium carbides and boron nitrides are larger than the interstitial openings in the FCC austenite crystal lattice, so are unable to be absorbed into the crystal lattice and distort the lattice to promote formation of martensite. If there is little or no carbon available to diffuse into the austenite lattice, the austenite lattice favors reversion back to the BCC or modified BCC ferrite lattice instead of martensite, even at fast cooling rates.

The presence of titanium in the steel tubular will lead to the formation of titanium nitrides and titanium carbides. It is believed that the presence of titanium nitrides and carbides also inhibit the presence of untempered martensite. Other metals that will form nitrides and/or carbides that inhibit the presence of untempered martensite include vanadium and molybdenum.

In order to more fully and clearly describe the present invention, the following examples are provided. These examples are intended to illustrate embodiments of the invention and do not limit the scope or spirit of the invention.

Trial and Heat Analyses

Welded steel tubulars having physical dimensions according to ASTM-A-53, Grade B, specifications were made according to a conventional electric resistance welding (ERW) process. The analysis of heat 712868 provided by the steel supplier and a comparative product analyses from traditionally processed samples 1 and 2, not including iron, which forms the balance are listed in Table 1. Both the trial heat and traditional product analysis do not have appreciable boron.

Trial Processing

During the trial the mill speed was incrementally changed as follows: 150 FPM, 200 FPM, 240 FPM, 280 FPM and finally 320 FPM for sample groups A-J. Several groups had the water to the OD scarfing tool turned off. The time for the pipe to traverse from the weld head to the OD scarfing tool ranged from 0.55 seconds to 0.74 seconds. The time to traverse to full water quench in preparation for ultrasonic evaluation of the weld ranged from 1.65 seconds to 2.22 seconds. The temperature of the edges of the skelp were heated to approximately 2790° F. when joined. The tubulars were immediately cooled at a rate of approximately 600° F./second and in about 3 seconds to a temperature less than approximately 600° F.

| Ex. | C | Mn | P | S | Si | Cu | Ni | Cr | Mo |
|---|---|---|---|---|---|---|---|---|---|
| 712868+ | .032 | .353 | .009 | .003 | .016 | .099 | .050 | .024 | .010 |
| 1* | .083 | .527 | .009 | .004 | .018 | .124 | .057 | .026 | .010 |
| 2* | .083 | .521 | .009 | .004 | .017 | .123 | .057 | .026 | .010 |

TABLE 1
Trial Heat and Traditional (w/o Nb) Product Analysis (wt. %)

| Ex. | Sn | Al | Ti | V | Nb | B | N₂ |
|---|---|---|---|---|---|---|---|
| 712868+ | .007 | .031 | .010 | .004 | .034 | .0001 | .0095 |
| 1* | .0081 | .0419 | .0033 | .0014 | .0042 | — | — |
| 2* | .0080 | .0372 | .0032 | .0013 | .0040 | — | — |

+Trial heat with niobium and no boron.
*Traditional non-niobium bearing steel

TABLE 2
Properties of Representative Trial Samples compared
to Traditionally Processed Samples 1 and 2

| | | Yield | | | Martensite |
|---|---|---|---|---|---|
| Sample | Chemistry | KSI | Tensile KSI | Elong % | Present |
| A-3 | Trial | 59.2 | 61.6 | 37 | No |
| B-3 | Trial | 61.1 | 64.5 | 32.6 | No |
| C-3 | Trial | 60.8 | 63.4 | 34.6 | No |
| D-3 | Trial | 61.7 | 64.6 | 36.3 | No |
| D-2 | Trial | 62.2 | 64.9 | 29.5 | No |
| D-6 | Trial | 65.2 | 68.7 | 30.7 | No |
| 1 | Traditional | 60.8 | 64.2 | 37.9 | Yes |
| 2 | Traditional | 60.1 | 63.8 | 36.9 | Yes |

Table 2 compares typical tensile, yield, and elongation properties for trial tubular samples A, B, C, and D with an average of 0.034 wt % niobium, with those from traditionally produced samples 1 and 2 with an average of 0.004% by weight Niobium. All results exceed the tensile, yield and elongation criteria of the ASTM-A-53, Grade B specification.

Metallographic Evaluation

Samples of tubular cross-sections were prepared for optical metallography per ASTM-E-3 “Preparation of Metallographic Specimens” and mounted cold in a castable resin to prevent tempering of the micro-structure by exposure to temperatures above 212° F. After polishing the castings, they were etched with 2% nital to delineate ferrite grain boundaries which are white, untempered martensite which is white to dull grey, and bainite which appears black. Within each cross-section, multiple fields were evaluated by ASTM-E-562 “Practice for Determining Volume Fraction by Systemic Manual Point Count.” Image analysis procedures such as ASTM-E-1245 “Determination of the Inclusion of Second Phase Constituent Content of Metals by Automatic Image Analysis” are also suitable.

Metallographic Results

Photomicrographs of cross-sections from samples A-D shown in Table 2 from the trial heat did not exhibit untempered martensite. In contrast samples 1 and 2 from the non-niobium bearing steel exhibited untempered martensite when evaluated by optical metallography at about 250× and about 500×.

While the present invention has been illustrated by the above description of embodiments, and while the embodiments have been described in some detail, it is not the intent of the applicants to restrict or in any way limit the scope of the invention to such detail. Additional advantages and modifications will appear to those skilled in the art. Therefore, the invention in its broader aspects is not limited to the specific details, representative apparatus and methods, and illustrative examples shown and described. Accordingly, departures may be made from such details without departing from the spirit or scope of the applicants' general or inventive concept.

1. A process for making a welded steel tubular, comprising:
a. forming sheet steel having a first edge and a second edge opposite the first edge into a cylindrical shape with the first edge and the second edge disposed substantially parallel to and spaced apart from each other;
b. heating the first edge and the second edge to a pre-selected temperature above an austenizing temperature at which the first edge and the second edge are molten or nearly molten;
c. causing the first edge and the second edge to join together into a welded seam, forming a steel tubular; and
d. rapidly cooling the welded seam to 400° F. or lower;
wherein the cooled welded seam is substantially free of untempered martensite.

2. The process of claim 1, further comprising cooling the welded seam at a rate of about 0.58° F./second or greater from the austenizing temperature.

3. The process of claim 2, further comprising cooling the welded seam at a rate of about 15° F./second or greater from the austenizing temperature.

4. The process of claim 3, further comprising cooling the welded seam at a rate of about 800° F./second or greater from the austenizing temperature.

5. The process of claim 4, further comprising cooling the welded seam at a rate of less than about 1600° F./second from the austenizing temperature.

6. The process of claim 1 conducted in the absence of annealing the welded seam after the welded seam is cooled.

7. The process of claim 1, wherein the steel tubular is not reheated to a temperature above about 1000° F. subsequent to cooling the welded seam.

8. The process of claim 1, wherein the steel tubular does not undergo a seam annealing process.

9. The process of claim 1, wherein heating the first edge and the second edge causes heating of a first heat affected zone adjacent to the first edge and a second heat affected zone adjacent the second edge.

10. The process of claim 9, further comprising cooling the first and the second heat affected zones, wherein the first and the second heat affected zones are substantially free of untempered martensite.

11. The process of claim 1, wherein heating the first edge and the second edge comprises use of electric resistance welding.

12. The process of claim 1, wherein the pre-selected temperature is at least about 2700° F.

13. The process of claim 1, wherein the steel tubular comprises:
a. between about 0.01 wt. % and about 0.1 wt. % carbon, and
b. between about 0.01 wt. % and about 0.2 wt. % niobium.

14. The process of claim 13, wherein the steel tubular comprises a weight ratio of niobium to carbon of between about 0.8 and about 2.

15. The process of claim 1, wherein the steel tubular comprises:
a. between about 0.001 wt. % and about 0.015 wt. % boron; and
b. between about 0.001 wt. % and about 0.015 wt. % nitrogen;
wherein the weight ratio of boron to nitrogen is between about 0.8 and about 2.1.

16. A process for making a welded steel tubular, comprising:
a. forming sheet steel having a first edge and a second edge opposite the first edge into a cylindrical shape with the first edge and the second edge disposed substantially parallel to and spaced apart from each other;
b. heating the first edge and the second edge to at least about 2700° F. by electric resistance welding;
c. causing the first edge and the second edge to join together into a welded seam, forming a steel tubular; and
d. rapidly cooling the welded seam to 400° F. or lower at a rate of about 0.58° F./second or faster;
wherein the steel tubular is not heated to a temperature above about 1000° F. subsequent to cooling the welded seam, and
wherein the steel tubular comprises between about 0.01 wt. % and about 0.1 wt. % carbon and between about 0.01 wt. % and about 0.2 wt. % niobium such that the weight ratio of niobium to carbon is between about 0.8 and about 2.1.

17. A steel tubular product comprising welded steel, the welded steel comprising:
a. between about 0.01 wt. % and about 0.2 wt. % carbon; and
b. between about 0.01 wt. % and about 0.2 wt. % niobium;
wherein the product is substantially free of untempered martensite.

18. The product of claim 17, wherein the weight ratio of niobium to carbon is at least about 0.8 for carbon concentrations below 0.20 wt. %.

19. The product of claim 17, wherein the weight ratio of niobium to carbon is between about 0.8 and about 2.1.

20. The product of claim 17, further comprising between about 0.001 wt. % and about 0.015 wt. % boron.

21. The product of claim 20, wherein the weight ratio of the niobium and boron to carbon is between about 0.8 and 2.1.

22. The product of claim 17, wherein the welded steel was rapidly quenched and made in the absence of seam annealing.

23. A steel tubular product comprising welded steel, the welded steel comprising between about 0.001 wt. % and about 0.015 wt. % boron and an amount of nitrogen such that the weight ratio of boron to nitrogen is between about 0.8 and about 2.1.

24. A steel tubular product of claim 23, wherein the steel is untempered martensite free.

25. A welded steel tubular made in accordance with the method of claim 1.
